(19) United States
(12) Patent Application Publication
(10) Pub. No.: US 2025/0191304 A1
(43) Pub. Date: Jun. 12, 2025

(54) PASSTHROUGH VIRTUAL REALITY DISPLAY WITH OPTIONAL REAL-WORLD DIRECT VIEW

(71) Applicant: Korea Electronics Technology Institute, Seongnam-si (KR)

(72) Inventors: Ji Soo HONG, Seoul (KR); Sung Hee HONG, Seoul (KR); Young Min KIM, Seoul (KR); Jin Soo JEONG, Seoul (KR); Yong Hwa KIM, Seoul (KR); Byoung Hyo LEE, Seoul (KR); Hyeon Chan OH, Seoul (KR)

(73) Assignee: Korea Electronics Technology Institute, Seongnam-si (KR)

(21) Appl. No.: 18/395,846

(22) Filed: Dec. 26, 2023

(30) Foreign Application Priority Data
Dec. 11, 2023 (KR) 10-2023-0178613

(51) Int. Cl. G06T 19/00; G02B 5/30

(52) U.S. Cl. CPC G06T 19/006; G02B 5/3025

(57) ABSTRACT

There is provided a passthrough virtual reality display with an optional real-world direct view. According to an embodiment, a passthrough virtual reality display system includes: a camera configured to generate a real-world image by shooting a front; a display panel configured to display the real-world image generated by the camera, and having some pixel missed; and a direct view image transmission unit configured to transmit a real-world direct view image entering from the front to the display panel, or block the real-world direct view image. Accordingly, when power supply is interrupted due to discharge of a battery, a real-world direct view image rather than a real-world image is displayed, so that a user can identify an outside situation and can be prevented from being confused or being placed in a dangerous situation.

### CROSS-REFERENCE TO RELATED APPLICATION(S) AND CLAIM OF PRIORITY

This application is based on and claims priority under 35 U.S.C. § 119 to Korean Patent Application No. 10-2023-0178613, filed on Dec. 11, 2023, in the Korean Intellectual Property Office, the disclosure of which is herein incorporated by reference in its entirety.

### BACKGROUND

### Field

The disclosure relates to a passthrough virtual reality display, and more particularly, to a passthrough virtual reality display which can display a real-world direct view image rather than a real-world image according to circumstances.

### Description of Related Art

FIG. 1 is a view illustrating a structure of a related-art passthrough virtual reality display. The passthrough virtual reality display refers to a display system that provides an extended reality experience in a virtual reality (VR) way by shooting a real world by using a camera mounted an outside of the display in order to provide a real-world image, performing a process of converting the real-world image into an image of a viewpoint appropriate to a user, and displaying an outside image through the display.

Through the passthrough virtual reality display, the disadvantage of a related-art VR device that does not allow a user to see an outside may be overcome, and a user may interact with a real world. However, when a passthrough virtual reality display is turned off due to discharge of a battery, there may be a problem that a real-world image is blocked and an outside situation cannot be identified, and accordingly, a user may be in a dangerous situation.

### SUMMARY

The disclosure has been developed in order to solve the above-described problems, and an object of the disclosure is to provide a passthrough virtual reality display with an optional real-world direct view, which blocks external light from a real world or allows a user to directly view a real world according to whether power is turned on or off.

According to an embodiment of the disclosure to achieve the above-described object, a passthrough virtual reality display system may include: a camera configured to generate a real-world image by shooting a front; a display panel configured to display the real-world image generated by the camera, and having some pixel missed; and a direct view image transmission unit configured to transmit a real-world direct view image entering from the front to the display panel, or block the real-world direct view image.

The display panel may have a center region where some pixels are missed.

Some missed pixels may allow incident light to pass therethrough as it is.

When power is not applied, the direct view image transmission unit may transmit the real-world direct view image to the display panel,

When power is applied, the direct view image transmission unit may block the real-world direct view image to the display panel.

The direct view image transmission unit may include: a first polarizer configured to allow only light of a first polarization of the incident real-world direct view image to pass therethrough; a polarization switcher positioned between the first polarizer and a second polarizer, and configured to, when power is not applied, change the light of the first polarization entering from the first polarizer to a second polarization by rotating by 90 degrees; and the second polarizer configured to allow only light of the second polarization to pass therethrough.

When power is applied, the polarization switcher may allow the light of the first polarization entering from the first polarizer to pass therethrough as it is.

The polarization switcher may be an LC element.

According to the disclosure, the passthrough virtual reality display system may further include: a first lens having a focal distance of f and disposed between a user and the display panel; and a second lens having a focal distance of −f and disposed at a front portion of the direct view image transmission unit.

According to another aspect of the disclosure, there is provided a passthrough virtual reality display method including: a step of generating, by a camera, a real-world image by shooting a front; a step of displaying, by a display panel having some pixels missed, the generated real-world image; and a step of transmitting, by a direct view image transmission unit, a real-world direct view image entering from the front to the display panel, or blocking the real-world direct view image.

According to still another aspect of the disclosure, there is provided a passthrough virtual reality display system including: a camera configured to generate a real-world image by shooting a front; a display panel configured to display the real-world image generated by the camera, and having some pixel missed; and a direct view image transmission unit configured to transmit a real-world direct view image entering from the front to the display panel in a specific situation.

According to yet another aspect of the disclosure, there is provided a passthrough virtual reality display method including: a step of generating, by a camera, a real-world image by shooting a front; a step of displaying, by a display panel having some pixels missed, the generated real-world image; and a step of transmitting, by a direct view image transmission unit, a real-world direct view image entering from the front to the display panel in a specific situation.

As described above, according to embodiments of the disclosure, an optional real-world direct view function is added to a passthrough virtual reality display, and, when power supply is interrupted due to discharge of a battery, a real-world direct view image rather than a real-world image is displayed, so that a user can identify an outside situation and can be prevented from being confused or being placed in a dangerous situation.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a structure of a related-art passthrough virtual reality display;

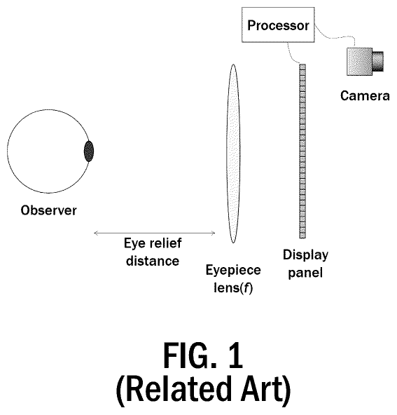

FIG. 2 is a view illustrating a structure of a passthrough virtual reality display system according to an embodiment of the disclosure;

FIG. 3 is a view illustrating a situation where power is applied and a real-world direct view image is blocked; and

FIG. 4 is a view illustrating a situation where power is not applied and a real-world direct view image is transmitted.

### DETAILED DESCRIPTION

Hereinafter, the disclosure will be described in more detail with reference to the accompanying drawings.

Embodiments of the disclosure provide a passthrough virtual reality display which can optionally provide a real-world direct view. The disclosure relates to a technology that can allow a user to identify an external environment through a real-world direct view when power is turned off, which is different from a related-art passthrough virtual reality display which blocks a real-world image when power is turned off and does not allow a user to identify an outside.

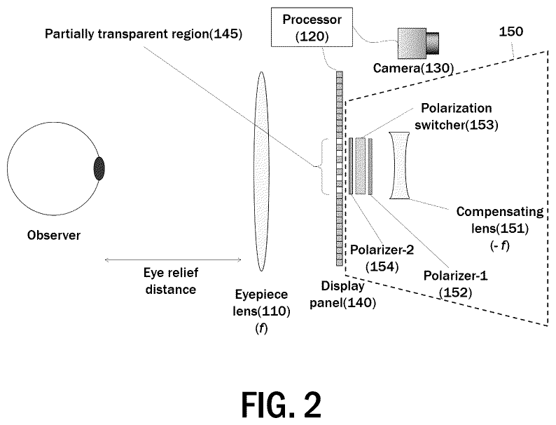

FIG. 2 is a view illustrating a structure of a passthrough virtual reality display system according to an embodiment of the disclosure. As shown in FIG. 2, the passthrough virtual reality display system according to an embodiment may include an eyepiece lens 110, a processor 120, a camera 130, a display panel 140, and a direct view image transmission unit 150.

The camera 130 generates a real-world image by shooting a front, and the processor 120 performs image-processing necessary for a real-world image generated by the camera 130 and displays an image on the display panel 140. A real-world image displayed on the display panel 140 is focused on user's pupil by the eyepiece lens 110.

The display panel 140 may be implemented by organic light emitting diodes (OLED). The display panel 140 has a center implemented by a partially transparent region as shown in FIG. 2. The partially transparent region has a structure in which some pixels are periodically missed, and the missed pixels pass incident light therethrough as it is.

The direct view image transmission unit 150 is an optical system that transmits a real-world direct view image (external light) entering from the front to the partially transparent region 145 of the display panel 140, or blocks the real-world direct view image.

Specifically, when power is applied, the direct view image transmission unit 150 blocks a real-world direct view image and does not transmit the real-world direct view image to the partially transparent region 145 of the display panel 140. On the other hand, when power is not applied, the direct view image transmission unit 150 may transmit a real-world direct view image to the partially transparent region 145 of the display panel 140.

The direct view image transmission unit 150, which performs the above-described function, includes a compensating lens 151, a polarizer-1 152, a polarization switcher 153, and a polarizer-2 154.

The polarizer-1 152 and the polarizer-2 154 have orthogonal polarizations. That is, the polarizer-1 152 is an optical element that allows only light of a first polarization to pass therethrough, and the polarizer-2 154 is an optical element that allows only light of a second polarization, which is orthogonal to light of the first polarization, to pass therethrough. The polarization switcher 153 is positioned between the polarizer-1 152 and the second polarizer-2 154.

When power is not applied, the polarization switcher 153 changes the light of the first polarization entering from the polarizer-1 152 to light of the second polarization by rotating by 90 degrees. On the other hand, when power is applied, the polarization switcher 153 allows the light of the first polarization entering from the polarizer-1 152 to pass therethrough as it is. The polarization switcher 153 may be implemented by a liquid crystal (LC) element.

The compensating lens 151 having a focal distance of −f to compensate for refractive power of the eyepiece lens 110 having a focal distance of f is disposed at a front portion of the direct view image transmission unit 150.

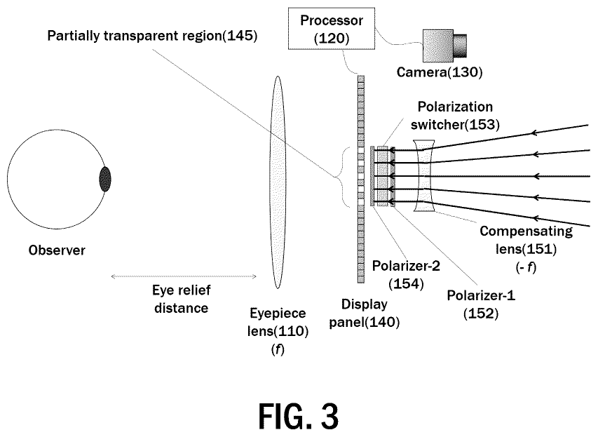

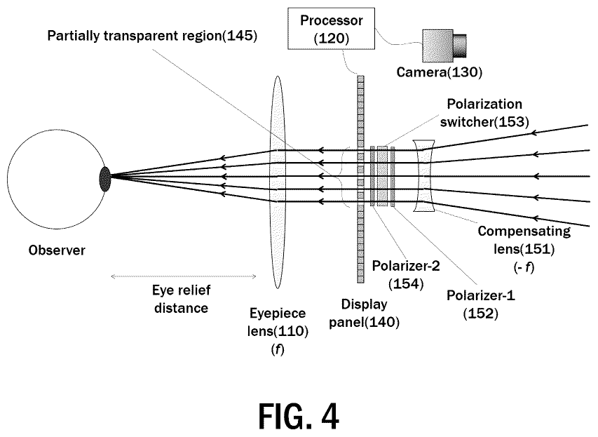

Hereinafter, a process of optionally providing a real-world direct view image to a user by the direct view image transmission unit 150 according to whether power is applied will be described in detail with reference to FIGS. 3 and 4.

FIG. 3 illustrates a situation where power is applied and real-world direct view light is blocked by the direct view image transmission unit 150. As shown in FIG. 3, when power is applied to the polarization switcher 153, only light of the first polarization of a real-world direct view image entering through the compensating lens 151 passes through the polarizer-1 152, and the polarizer switcher 153 to which power is applied allows the light of the first polarization to pass therethrough as it is, such that the light of the first polarization does not pass through the polarizer-2 154.

A user is not disturbed in viewing a real-world image shot by the camera 130 through the display panel 140.

FIG. 4 illustrates a situation where power is not applied and real-world direct view light is transmitted by the direct view image transmission unit 150. When power is not applied, a battery of the passthrough virtual reality display is discharged and the processor 120, the camera 130, the display panel 140 are not normally operated.

Only light of the first polarization of the real-world direct view light entering through the compensating lens 151 passes through the polarizer-1 152, and the polarizer switcher 153 to which power is not applied changes the light of the first polarization to light of the second polarization by rotating by 90 degrees, such that light of the second polarization passes through the polarizer-2 154.

A real-world direct view image of the second polarization passing through the polarizer-2 154 passes through the missed pixels formed on the partially transparent region 145 of the display panel 140, and enters user's pupil through the eyepiece lens 110. Accordingly, the user can see the real-world direct view image.

Up to now, a passthrough virtual reality display with an optional real-world direct view has been described with reference to preferred embodiments.

In the above-described embodiments, an optional real-world direct view function is added to a passthrough virtual reality display, and, when power supply is interrupted due to discharge of a battery, a real-world direct view image rather than a real-world image is displayed, so that a user can identify an outside situation and can be prevented from being confused or being placed in a dangerous situation.

A power supply switch may be added to the polarization switcher 153 to allow a user to manually control power, in addition to automatically displaying a real-world direct view image due to interruption of power supply, so that a direct view image of an outside real world can be provided according to user's selection.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A passthrough virtual reality display system comprising:
a camera configured to generate a real-world image by shooting a front;
a display panel configured to display the real-world image generated by the camera, and having some pixel missed; and
a direct view image transmission unit configured to transmit a real-world direct view image entering from the front to the display panel, or block the real-world direct view image.

2. The passthrough virtual reality display system of claim 1, wherein the display panel has a center region where some pixels are missed.

3. The passthrough virtual reality display system of claim 2, wherein some missed pixels allow incident light to pass therethrough as it is.

4. The passthrough virtual reality display system of claim 1, wherein the direct view image transmission unit is configured to, when power is not applied, transmit the real-world direct view image to the display panel,

5. The passthrough virtual reality display system of claim 4, wherein the direct view image transmission unit is configured to, when power is applied, block the real-world direct view image to the display panel.

6. The passthrough virtual reality display system of claim 5, wherein the direct view image transmission unit comprises:
a first polarizer configured to allow only light of a first polarization of the incident real-world direct view image to pass therethrough;
a polarization switcher positioned between the first polarizer and a second polarizer, and configured to, when power is not applied, change the light of the first polarization entering from the first polarizer to a second polarization by rotating by 90 degrees; and
the second polarizer configured to allow only light of the second polarization to pass therethrough.

7. The passthrough virtual reality display system of claim 6, wherein the polarization switcher is configured to, when power is applied, allow the light of the first polarization entering from the first polarizer to pass therethrough as it is.

8. The passthrough virtual reality display system of claim 7, wherein the polarization switcher is an LC element.

9. The passthrough virtual reality display system of claim 1, further comprising:
a first lens having a focal distance of f and disposed between a user and the display panel; and
a second lens having a focal distance of −f and disposed at a front portion of the direct view image transmission unit.

10. A passthrough virtual reality display method comprising:
a step of generating, by a camera, a real-world image by shooting a front;
a step of displaying, by a display panel having some pixels missed, the generated real-world image; and
a step of transmitting, by a direct view image transmission unit, a real-world direct view image entering from the front to the display panel, or blocking the real-world direct view image.

11. A passthrough virtual reality display system comprising:
a camera configured to generate a real-world image by shooting a front;
a display panel configured to display the real-world image generated by the camera, and having some pixel missed; and
a direct view image transmission unit configured to transmit a real-world direct view image entering from the front to the display panel in a specific situation.
